(19) United States
(12) Patent Application Publication
(10) Pub. No.: US 2011/0176989 A1
(43) Pub. Date: Jul. 21, 2011

(54) PROCESS FOR PRODUCING CHLORINE DIOXIDE USING WASTE GLYCEROL FROM A BIODIESEL PLANT

(76) Inventors: Naceur Jemaa, Pointe-Claire (CA); Michael Paleologou, Beaconsfield (CA)

(21) Appl. No.: 13/120,249

(22) PCT Filed: Sep. 22, 2009
(86) PCT No.: PCT/CA09/01331

§ 371 Date: Mar. 22, 2011

Related U.S. Application Data
(60) Provisional application No. 61/136,678, filed on Sep. 24, 2008.

(51) Int. Cl. C01B 11/02

(52) U.S. Cl. 423/479

(57) ABSTRACT

A process for chlorine dioxide production uses waste glycerol from biodiesel plants as a reducing agent. This untreated waste stream may contain other reducing agents such as sodium chloride and methanol which were found to enhance the chlorine dioxide production. Other chemicals present in this waste stream did not affect the operation of the chlorine dioxide generator. Substituting the waste glycerol for methanol or other reducing agents helps kraft pulp mills in reducing the cost of producing chlorine dioxide while providing a use for the untreated waste glycerol stream.

### TECHNICAL FIELD

This invention relates to the use of a waste glycerol, more especially a waste glycerol stream, from a biodiesel plant to produce chlorine dioxide. No purification is required as the presence of sodium chloride and methanol in the waste glycerol enhances ClO₂ generation. The presence of other chemicals in the waste glycerol is not problematic.

### BACKGROUND ART

Chlorine dioxide used for pulp bleaching is manufactured using an alkali metal chlorate in highly acidic medium. A reducing agent such as methanol, sodium chloride, and sulphur dioxide are suitable for this purpose. U.S. Pat. No. 6,761,872, U.S. Pat. No. 6,790,427, and U.S. Pat. No. 5,066,477 describe processes for ClO₂ production. Attempts to find other reducing agents have been made. U.S. Pat. No. 5,093,097 presents a process for chlorine dioxide production using alcohols with the formula CH₂OH(CHOH)CH₂OH as reducing agents. Pure glycerol was mentioned and employed as a reducing agent. None of the alcohols mentioned are currently used in the chlorine dioxide generation most probably due to their high cost.

Waste glycerol from biodiesel plants contains mainly glycerol and other impurities such as sodium chloride, methanol, sodium hydroxide and traces of unreacted fatty acids. Generally, these streams are purified to produce pure glycerol to be used for other applications. The purification step involves a number of separation units and can be costly. Currently, this waste stream has very limited uses due to the presence of these impurities.

### DISCLOSURE OF THE INVENTION

This invention seeks to provide a new use for a waste liquid containing glycerol derived from biodiesel production.

This invention further seeks to provide a process for the production of chlorine dioxide in which a waste liquid containing glycerol derived from biodiesel production is employed as a reducing agent.

In accordance with one aspect of the invention there is provided in a process for the production of chlorine dioxide by reacting an alkali metal chlorate, mineral acid and a reducing agent the improvement wherein the reducing agent is provided by a waste liquid containing glycerol derived from biodiesel production.

In another aspect of the invention there is provided use of a waste liquid containing glycerol derived from biodiesel production, as a reducing agent in the production of chlorine dioxide by reacting an alkali metal chlorate, mineral acid and a reducing agent.

In still another aspect of the invention there is provided a process for producing chlorine dioxide comprising:

a) providing a waste liquid containing glycerol recovered from biodiesel production,
b) reacting an alkali metal chlorate, mineral acid and said waste liquid, as reducing agent for chlorine dioxide production; and
c) recovering chlorine dioxide from said reacting in b).

The waste liquid in a) is, in particular, recovered intact from a biodiesel production which comprises triglyceride esterification with methanol to produce the biodiesel and glycerol.

### DETAILED DESCRIPTION OF THE INVENTION

Biodiesel is an alternative fuel for diesel engines. Its production from renewable resources is gaining ground in North America and in the rest of the world. The most common path for biodiesel production is triglyceride transesterification. In this process, vegetable oil, for instance, is contacted with an alcohol (e.g., methanol) in the presence of a catalyst such as sodium hydroxide or potassium hydroxide. The products from this step are fatty acid alkyl esters, i.e. biodiesel, with glycerol being the main by-product. In future, it is expected that several biodiesel plants will be in operation to meet the increasing demand for biodiesel fuel. On the other hand, the generation of glycerol, as a by-product, will far exceed demand. For every 10 tones of biodiesel produced there is 1 ton of glycerol available for use. Therefore, other uses for glycerol are needed to meet future productions.

Glycerol waste stream from a biodiesel plant is a by-product stream which consists mainly of glycerol, methanol, and the used catalyst (NaOH/KOH). Typically the waste by-product stream is rich in glycerol which may amount typically to 80% to 90%, more especially to 85%, by weight, of the waste by-product stream. It may contain inorganic salts such as Na₂SO₄, K₂SO₄, NaCl (up to 15%, more typically up to 10% by weight, and more typically 3 to 4%, by weight) and traces of the unreacted vegetable oil, fatty acids as well as traces of the product biodiesel. Methanol content in crude glycerol may be as high as 27% by weight, and is typically about 8%, by weight. Total inorganics may be up to 20%, typically about 6%, by weight. Biodiesel and water may be present in minor amounts, typically less than 0.5% and 0.1%, respectively. Surprisingly the presence of biodiesel and other impurities does not affect the chlorine dioxide production.

Biodiesel may be produced in an acid catalyzed, process; an alkali catalyzed; or a two step acid catalyzed and alkali catalyzed process. The amount of salt such as NaCl present in the waste liquid containing glycerol depends on the process used; neutralisation of an alkali catalyzed process with hydrochloric acid, results in NaCl in the waste liquid, as does neutralisation of an acid catalyzed process employing HCl, with NaOH. The present invention provides a novel use of a waste by-product from biodiesel plants, which plants are growing in number. Waste glycerol produced during the production of biodiesel contains several impurities such as methanol, sodium chloride, other salts, and may also contain traces of unreacted triglycerides and fatty acids which may be present in the triglycerides employed in the biodiesel production and may also result from incomplete transesterification of triglycerides. The purification of the waste glycerol is required to obtain pure glycerol to be used in the manufacture of several other chemicals. This purification step may be complicated and costly. However, in accordance with the present invention, this untreated by-product can be used in kraft pulp mills, in the chlorine dioxide generator, for the production of chlorine dioxide.

Waste glycerol can be added to a mixture of sodium chlorate and sulphuric acid to produce chlorine dioxide, used for pulp bleaching. Impurities such as methanol and sodium chloride act as reducing agents and enhance the ClO₂ production. Under the same operating conditions, trials using pure methanol, pure glycerol and waste glycerol were performed using Paprican's chlorine dioxide generator. In terms of the amount of ClO₂ produced, it was found that one mole of glycerol was equivalent to about 3 moles of methanol. On a mass basis, the same amount of methanol or glycerol produces the same amount of ClO₂.

Under the same mass flow rate of methanol and glycerol to the generator, the waste glycerol by-product stream generated higher ClO₂ production rate. This increase was attributed to the presence of sodium chloride. The presence of other impurities such as unreacted triglycerides, fatty acids or traces of biodiesel had no effect on the operation of the generator. A trial using the chlorine dioxide generator has confirmed the suitability of this waste stream as a reducing agent.

The invention allows pulp mills to reduce or eliminate the consumption of purchased methanol in the ClO₂ generator while reducing the cost of ClO₂ produced and eliminating or reducing any operational costs associated with the purification of this waste glycerol by-product from biodiesel plants. In addition, waste glycerol is a safer chemical to work with compared to methanol. It has higher boiling point, and so much less will be evaporated and lost during the production of ClO₂. Furthermore waste glycerol is not as flammable as methanol.

One way of producing chlorine dioxide, using methanol as a reducing agent, is through the following reaction:

3NaClO₃+0.7CH₃OH+2H₂SO₄→3ClO₂+0.1CO₂+2.3H₂O+0.6HCOOH+Na₃H(SO₄)₂

The reaction is suitably operated in a reactor vessel, at a temperature of 50-100° C., preferably 50-75° C., and at a pressure below atmospheric pressure, suitably at 60-400 mm Hg. The reaction medium is then heated or water is evaporated in a sufficient amount for diluting the chlorine dioxide produced to a safe concentration. The acid strength in the reactor is adjusted by adding sulfuric acid or another mineral acid. In the reactor, the alkali metal salt of the mineral acid is continuously crystallized and separated in a suitable manner. The process is not restricted to any of the alkali metals, but sodium is the most preferred

The acid strength of the reaction medium may be held within a wide range, suitably within the range 2-11N. At a lower acidity, between about 2 and about 4.8, neutral alkali metal sulphate is formed, which is an advantage, e.g. from a corrosive point of view, but in the mean time the chlorine dioxide reaction is slower than it is at higher acidities.

The teachings of U.S. Pat. No. 5,093,097 are incorporated herein by reference, particularly with respect to suitable process conditions for the generation of chlorine dioxide by the modified process of the invention.

The generation of ClO₂ can take place according to the above reaction where 0.7 moles of methanol are required for every 3 moles of ClO₂ produced. Substitution of methanol with glycerol at 60-70° C. yielded chlorine dioxide during an exploratory laboratory test. About 0.6 g of NaClO₃ was dissolved in water. About 1 ml of 60% H₂SO₄ was added to the mixture. One droplet of pure glycerol was added. The clear solution quickly changed colour to dark yellow upon heating. Chlorine dioxide smell was noticeable in the vial and was destroyed upon the addition of sodium sulphite. Paprican's chlorine dioxide pilot plant was employed and showed that for the above reaction about one third of the methanol molar rate is needed to produce the same amount of ClO₂, when employing the waste glycerol liquid of the invention

The waste product from the biodiesel plant typically also contains sodium chloride and unused methanol which will also act as reducing agents for the above reaction. Methanol recovery after the transesterification reaction is unnecessary and can be avoided since it will be consumed in the chlorine dioxide generator. The catalyst, NaOH or KOH, reacts with acid in the generator to produce sodium sulphate or potassium sulphate. The use of a waste glycerol from a biodiesel plant will help kraft mills reduce the cost of chlorine dioxide production. Kraft mills using hydrogen peroxide as a reducing agent in the generator can reduce the cost of making ClO₂ by switching to waste glycerol.

The use of untreated glycerol in the production of ClO₂ can save the treatment expenses associated with purification of the waste glycerol in the prior art, and partially addresses the surplus issue that may arise from the spread of biodiesel plants. The presence of methanol and/or sodium chloride in the waste glycerol enhances the chlorine dioxide generation.

In addition, methanol is very volatile (boiling point: 65° C.) and during chlorine dioxide production a considerable amount is evaporated and does not participate in the process. It has been estimated that only about 40% of the methanol is used efficiently. The consumption of methanol is about 190-200 kg/ton of ClO₂ while the theoretical amount can be as low as 79 kg/ton depending on the reaction of the process as mentioned in U.S. Pat. No. 4,770,868. The lost methanol reacts with ClO₂ and reduces the generator efficiency. In addition, the evaporated methanol tends to be corrosive. Glycerol, present in the waste glycerol stream, has a higher boiling point, 290° C. and will not escape the solution under the operating conditions of the ClO₂ generator. Therefore, by using the waste glycerol, in accordance with the invention, the generator is expected to operate more efficiently.

### EXAMPLES

In a first pilot unit trial (trial 1), sodium chlorate and sulphuric acid in the feed solution were flowing at the following concentrations 1.85M and 7.5 N, respectively. The reactor temperature was kept at 65° C. In the first case, methanol (at 20% wt) was pumped at a rate of 1.24 g/min. The chlorine dioxide production was about 9.8 g/min under these conditions. In a subsequent case, pure glycerol (at 20% wt) was feed to the generator at a rate of 1.18 g/min. The chlorine dioxide rate was about 9.9 g/min. The rate of ClO₂ produced using methanol or glycerol was about the same under the above experimental conditions. It was found that one mole of glycerol was equivalent to three moles of methanol in terms of ClO₂ yield. The trial using pure glycerol lasted a few hours and no operational problems have been observed. Other experimental conditions can also be employed i.e. different sulphuric acid, sodium chlorate, methanol, and glycerol concentrations and different temperature and pressure.

In a second pilot unit trial (trial 2), waste glycerol from a biodiesel plant was employed. The glycerol and chloride concentrations were about 56.7% and 3.3% by weight, respectively. Methanol was not detected in this sample. In the control experiment, pure methanol (at 20% wt) was added to a feed solution of sodium chlorate and sulphuric acid. The chlorate and acid concentrations were about 1.85M and 7.5 N, respectively. In a subsequent experiment, glycerol in the waste stream was diluted to about 20% and added to the solution having the above concentrations of chlorate and acid. The amount of chlorine dioxide produced in these trials was monitored. It was found that waste glycerol, fed at the same mass rate as methanol in the control, or one mole of glycerol for 3 moles of methanol, produces about 20% more chlorine dioxide than the control run. This increase can be mainly attributed to the presence of sodium chloride in the waste glycerol stream. The molar ratio of chloride to glycerol in the solution was about 0.15. The increase of the amount of ClO₂ produced will depend on the initial concentration sodium chloride, and any methanol present in the waste glycerol stream.

Table I shows a summary of the trial results. The rate of chlorine dioxide produced per gram of pure glycerol was about 3.70 g of ClO₂/min. In the case of waste glycerol it ranged from 4.22 to 4.28 g of ClO₂/min (an increase of about 15%). This increase is attributed to the presence of other reducing agents in the waste glycerol (sodium chloride in this case). Compared to pure methanol waste glycerol increased the rate of ClO₂ produced by about 20%.

Each trial lasted a few hours and no operational problems have been observed. The chlorine dioxide production was steady. In these trials, the ratio of Cl₂ over ClO₂ produced was about 1%. The use of waste glycerol did not enhance the Cl₂ production.

TABLE I
results of the pilot trials

| | | | Rate of | | |
|---|---|---|---|---|---|
| | | | reducing | | Rate of ClO2 |
| | | | agent | Rate of ClO2 | produced per |
| | | | addition | production | g of reducing |
| | | Wt % | g/min | g/min | agent |
| Pilot | Pure methanol | 20% | 1.24 | 9.80 | 3.48 |
| trial | Pure Glycerol | 20% | 1.18 | 9.90 | 3.70 |
| 1 | | | | | |
| Pilot | Pure methanol | 20% | 1.30 | 9.96 | 3.38 |
| trial | Waste | 20% | 1.06 | 10.25 | 4.28 |
| 2 | glycerol | | | | |
| | Waste | 20% | 0.98 | 9.39 | 4.22 |
| | glycerol | | | | |

1. In a process for the production of chlorine dioxide by reacting an alkali metal chlorate, mineral acid and a reducing agent the improvement wherein the reducing agent is provided by a waste liquid containing up to 90%, by weight, glycerol derived from biodiesel production, based on the weight of waste liquid, and said waste liquid further comprising unreacted vegetable oil employed in said biodiesel production.

2. A process as claimed in claim 1, wherein said waste liquid further comprises sodium chloride derived in said biodiesel production.

3. A process as claimed in claim 1, wherein said waste liquid further comprises unreacted methanol from said biodiesel production.

4. A process as claimed in claim 1, wherein said waste liquid contains 56% to 90%, by weight, glycerol based on the weight of waste liquid.

5. A process as claimed in claim 1, wherein said reacting is in a reaction vessel and said alkali metal chlorate, mineral acid and reducing agent are in such proportions that chlorine dioxide is produced in a reaction medium which is maintained at a temperature of from about 50° C. to about 100° C. and at an acidity within a range of from about 2 to about 11 N and which is subjected to subatmospheric pressure sufficient for evaporating water, a mixture of chlorine dioxide and water vapor being withdrawn from an evaporation zone in the reaction vessel.

6. A process as claimed in claim 5, wherein alkali metal sulfate is precipitated in a crystallization zone in the reaction vessel.

7. A process for producing chlorine dioxide comprising:
a) providing a waste liquid containing up to 90%, by weight, glycerol recovered from biodiesel production, based on the weight of waste liquid, and unreacted vegetable oil employed in said biodiesel production,
b) reacting an alkali metal chlorate, mineral acid and said waste liquid, as reducing agent, for chlorine dioxide production; and
c) recovering chlorine dioxide from said reacting in b).

8. A process as claimed in claim 7, wherein said waste liquid in
a) is recovered intact from a biodiesel production which comprises triglyceride esterification with methanol to produce said biodiesel and glycerol.

9. A process as claimed in claim 7, wherein said waste liquid further comprises sodium chloride derived in said biodiesel production.

10. A process as claimed in claim 7, wherein said waste liquid further comprises unreacted methanol from said biodiesel production.

11. A process as claimed in claim 7, wherein said waste liquid comprises unreacted triglyceride employed in said biodiesel production.

12. (canceled)

13. A process as claimed in claim 2, wherein said waste liquid further comprises unreacted methanol from said biodiesel production.

14. A process as claimed in claim 2, wherein said waste liquid contains 56% to 90%, by weight, glycerol based on the weight of waste liquid.

15. A process as claimed in claim 3, wherein said waste liquid contains 56% to 90%, by weight, glycerol based on the weight of waste liquid.

16. A process as claimed in claim 2, wherein said reacting is in a reaction vessel and said alkali metal chlorate, mineral acid and reducing agent are in such proportions that chlorine dioxide is produced in a reaction medium which is maintained at a temperature of from about 50° C. to about 100° C. and at an acidity within a range of from about 2 to about 11N and which is subjected to subatmospheric pressure sufficient for evaporating water, a mixture of chlorine dioxide and water vapor being withdrawn from an evaporation zone in the reaction vessel.

17. A process as claimed in claim 3, wherein said reacting is in a reaction vessel and said alkali metal chlorate, mineral acid and reducing agent are in such proportions that chlorine dioxide is produced in a reaction medium which is maintained at a temperature of from about 50° C. to about 100° C. and at an acidity within a range of from about 2 to about 11N and which is subjected to subatmospheric pressure sufficient for evaporating water, a mixture of chlorine dioxide and water vapor being withdrawn from an evaporation zone in the reaction vessel.

18. A process as claimed in claim 4, wherein said reacting is in a reaction vessel and said alkali metal chlorate, mineral acid and reducing agent are in such proportions that chlorine dioxide is produced in a reaction medium which is maintained at a temperature of from about 50° C. to about 100° C. and at an acidity within a range of from about 2 to about 11N and which is subjected to subatmospheric pressure sufficient for evaporating water, a mixture of chlorine dioxide and water vapor being withdrawn from an evaporation zone in the reaction vessel.

19. A process as claimed in claim 8, wherein said waste liquid further comprises sodium chloride derived in said biodiesel production.

20. A process as claimed in claim 8, wherein said waste liquid further comprises unreacted methanol from said biodiesel production and unreacted triglyceride employed in said biodiesel production.

21. A process as claimed in claim 9, wherein said waste liquid further comprises unreacted methanol from said biodiesel production and unreacted triglyceride employed in said biodiesel production.
